(19) United States
(12) Patent Application Publication
(10) Pub. No.: US 2016/0104571 A1
(43) Pub. Date: Apr. 14, 2016

(54) SINTERED MAGNET PRODUCTION MOLD, AND SINTERED MAGNET PRODUCTION METHOD USING THE SAME

(71) Applicant: INTERMETALLICS CO., LTD., Nakatsugawa-shi, Gifu (JP)

(72) Inventors: Kazuyuki KOMURA, Kyoto-shi (JP); Masato SAGAWA, Kyoto-shi (JP)

(73) Assignee: INTERMETALLICS CO., LTD., Nakatsugawa-shi, Gifu (JP)

(21) Appl. No.: 14/785,750

(22) PCT Filed: Mar. 18, 2014
(86) PCT No.: PCT/JP2014/057263

§ 371 Date: Oct. 20, 2015

(30) Foreign Application Priority Data
Apr. 24, 2013 (JP) 2013-091174

(51) Int. Cl. H01F 41/02; H01F 1/057; B22F 1/00; B22F 3/10; B22F 3/00

(52) U.S. Cl. CPC H01F 41/0266; B22F 3/10; B22F 3/004; B22F 1/0081; H01F 1/0577; H01F 41/0273

(57) ABSTRACT

A sintered magnet production mold which can improve the uniformity in the filling density of the alloy powder. The main body has a main cavity formed inwards from a main-body surface and a side cavity provided on the outside of the opening of the upper cavity on the main-body surface at each of the two ends of the opening in the axial direction of the aforementioned partial cylinder, the side cavity formed inwards from the main-body surface and shaped like a partial cylinder having an axis parallel to the axis of the partial cylinder of the lower cavity. The cover has a base surface corresponding to the main-body surface and a convex rib bulging from the base surface, the convex rib having a shape corresponding to the two side cavities and a virtual cavity shaped like a partial cylinder connecting the two side cavities.

### TECHNICAL FIELD

The present invention relates to a mold for producing a sintered magnet, such as an RFeB system containing a rare-earth R (which represents one or more elements selected from the group of Sc, Y, La, Ce, Pr, Nd, Pm, Sm, Eu, Gd, Tb, Dy, Ho, Er, Tm, Yb and Lu), Fe and B (R₂Fe₁₄B), an RCo system containing R and Co (RCo₅ or R₂Co₁₇), or a similar type of sintered magnet, as well as a method for producing a sintered magnet using the same mold.

### BACKGROUND ART

RFeB system sintered magnets have the characteristic that most of their magnetic characteristics (e.g. residual magnetic flux density) are far better than those of other conventional permanent magnets. Therefore, RFeB system sintered magnets are used in a variety of products, such as driving motors for hybrid or electric automobiles, battery-assisted bicycle motors, industrial motors, voice coil motors (used in hard disk drives or other apparatuses), high-grade speakers, headphones, and permanent magnetic resonance imaging systems.

For the production of RFeB system sintered magnets, a method including the following processes has been conventionally used: the cavity of a mold is filled with a fine powder of starting alloy (filling process; the powder is hereinafter called the “alloy powder”) and a magnetic field is applied to the alloy powder in the cavity to orient the particles of the alloy powder (orienting process), after which pressure is applied to the alloy powder to produce a compression-molded compact (compression-molding process), and the compression-molded compact is heated to be sintered (sintering process). A variation of this method has also been used in which, after the filling process, the orienting process and the compression-molding process are simultaneously performed by applying pressure with a pressing machine while applying a magnetic field to the alloy powder. In any cases, these methods use a pressing machine for compression molding. Therefore, in the present application, these methods are called the “pressing method.”

Earlier versions of the RFeB system sintered magnet produced by the pressing method has the drawbacks that the coercivity will be comparatively low if the rare earth R is Nd, Pr and/or other light rare-earth elements, and the maximum energy product will be low if the rare earth R is Dy, Tb and/or other heavy rare-earth elements. To overcome these drawbacks, the following methods have been used: (1) a method in which an RFeB system sintered magnet is produced from a raw material prepared by mixing a powder of RFeB system alloy containing a light rare-earth element and a powder of a pure substance or compound of a heavy rare-earth element, such as Dy and/or Tb (binary alloy blending technique); (2) a method in which a powder of a heavy rare-earth element is applied to the surface of an RFeB system sintered compact containing a light rare-earth element and is heated to introduce the heavy rare-earth element through the grain boundaries in the sintered compact into regions near the surface of the grains of the RFeB system (grain boundary diffusion method), and (3) a method in which the grain size of the individual grains constituting the RFeB system sintered magnet is reduced (to 4 μm or smaller, and preferably 2 μm or smaller). Among those methods, (3) is advantageous in that it can be applied regardless of the kind of rare earth R. However, the method has the problem that reducing the grain size increases the surface area of the grains and allows the grains to be easily oxidized. An oxidization of the grains lowers the maximum energy product. Furthermore, it may possibly cause ignition.

In recent years, a method in which an RFeB system sintered magnet is produced by performing the orienting and sintering processes on an alloy powder held in a cavity without applying pressure for molding has been found (Patent Literature 1) as a method which is suitable for method (3) and is capable of solving the previously described problem related to method (3). In the present application, such a method of producing a sintered magnet without performing the compression-molding process is called the “PLP (press-less process) method.” In the PLP method, since it is unnecessary to use a pressing machine, the processes from the filling with the alloy powder to the sintering can be easily performed in an inert-gas atmosphere. Therefore, in the PLP method, an alloy powder whose average particle size is smaller than can be handled in the pressing method can be used with little oxidization. Thus, it is possible to improve the coercivity of the sintered magnet while reducing the amount of decrease in its maximum energy product. The absence of the pressure applied to the alloy powder during the orienting process allows the alloy particles to be easily oriented in the orienting process. Similarly, the absence of the pressure applied to the alloy powder after the orienting process means that the oriented state will not be disordered by pressure application. Thus, the amount of decrease in the maximum energy product which accompanies the increase in the coercivity can be even more reduced.

In the PLP method, a sintered magnet having a shape close to that of the cavity (“near-net shape”) is obtained. For example, since the magnets used in the rotor of a motor are normally shaped like a rectangular or square plate curved into an arched form (“arched plate”), a mold described in Patent Literature 1 has a cavity shaped like an arched plate so as to create an RFeB system sintered magnet having such a shape. The arched plate magnets are also called the “segment magnets”, since the rotor has a plurality of arched plate magnets which are arranged next to each other on a circle and look like a single cylindrical magnet divided into segments.

In the mold described in Patent Literature 1, the cavity is designed in such a manner that the convex surface 91, concave surface 92 and rectangular side surfaces 93 of the arched plate magnet 90 (see FIG. 12) extend vertically, i.e. in the direction parallel to the depth direction. A plurality of such cavities are arranged in the mold, with their convex surfaces 91 (or concave surfaces 92) parallel to each other. Each cavity has an opening on the side corresponding to the arched side surface 94 (FIG. 12) of the arched plate magnet. Through this opening, an alloy powder is supplied to the cavity.

### CITATION LIST

### Patent Literature

Patent Literature 1: WO 2006/004014 A

### SUMMARY OF INVENTION

### Technical Problem

In the mold described in Patent Literature 1, the area of the opening as compared to the depth of the cavity is small. Therefore, the filling density of the alloy powder at the bottom of the cavity is likely to be insufficient, and the overall filling density tends to be nonuniform. Furthermore, the inside of the cavity is difficult to clean.

If such a cavity is singly used, the alloy powder will be scattered from the opening due to the magnetic force in the orienting process, or it will be spilled from the opening due to the expansion by heat in the sintering process. Therefore, it is necessary to attach a cover to the opening of the mold. According to Patent Literature 1, the cover is loosely fitted in (the cavity of) the mold. Such a fitting of the cover in the cavity requires the fitting dimensions of the two components to be determined with high accuracy. However, this causes the problem that the cover cannot be removed from the mold after the sintering if the alloy powder is caught in the fitting areas.

The problem to be solved by the present invention is to provide a sintered magnet production mold which can improve the uniformity in the filling density of the alloy powder, which allows its inside to be easily cleaned, and in which the dimensions of the cover and the cavity do not need to be determined with high accuracy and yet the alloy powder is hardly caught in the gap between the cover and the cavity, as well as to provide a sintered magnet production method using the same mold.

### Solution to Problem

The present invention developed for solving the previously described problem is a sintered magnet production mold having a main body and a cover, wherein:

a) the main body has:
a-1) a main cavity formed inwards from a main-body surface, including an upper cavity shaped like a rectangular parallelepiped and a lower cavity shaped like a downward-convex partial cylinder directly joined to the deeper end of the upper cavity; and
a-2) a side cavity provided on the outside of the opening of the upper cavity on the main-body surface at each of the two ends of the opening in the axial direction of the aforementioned partial cylinder, the side cavity formed inwards from the main-body surface and shaped like a partial cylinder having an axis parallel to the axis of the partial cylinder of the lower cavity;
   and

b) the cover has a base surface corresponding to the main-body surface and a convex rib bulging from the base surface, the convex rib having a shape corresponding to the two side cavities and a virtual cavity shaped like a partial cylinder connecting the two side cavities.

In the sintered magnet production mold according to the present invention, after an alloy powder is supplied through the opening of the upper cavity to the main cavity, the cover is attached to the main body by placing the cover onto the main body so that the convex rib matches the side cavities. As a result, the alloy powder is confined in the space shaped like an arched plate formed in the main cavity below the convex rib. The opening of the upper cavity is on the concave side of the arched-plate-like space, and has a larger area than the opening provided on the arched side surface in the conventional mold. Therefore, the alloy powder can be more easily placed in the cavity, which leads to a higher degree of uniformity in the filling density of the alloy powder. Furthermore, the cleaning task is easier to perform.

In the sintered magnet production mold according to the present invention, the task of attaching the cover to the main body merely requires placing the cover onto the main body so that the convex rib matches the side cavities; it is unnecessary to fit the cover into the cavity. Therefore, it is unnecessary to determine the dimensions of the cover and the cavity with high accuracy, and the alloy powder cannot be caught between the cover and the main body. Even if a small amount of alloy powder enters the gap between the side cavity and the convex rib and becomes melted in the sintering process, the cover can be easily removed from the mold by sliding it in the longitudinal direction of the convex rib after the sintering process.

The main body may be provided with a plurality of main cavities.

In this case, the main body should preferably have at least some of the plurality of main cavities arranged in one direction, with a common side cavity provided between the main cavities neighboring each other in the aforementioned direction, while the cover should preferably have the convex rib shaped like a partial cylinder longer than the distance between the two ends of the plurality of cavities arranged in the one aforementioned direction. Such a configuration requires only one cover to be attached for the plurality of cavities, so that the task of attaching and removing the cover will be less cumbersome.

The sintered magnet production method according to the present invention includes the following successive processes:

a filling process, in which a sintered magnet production mold according to the present invention is filled with an alloy powder as a raw material;

an orienting process, in which the alloy powder is magnetically oriented by applying a magnetic field to the alloy powder without applying pressure; and

a sintering process, in which the alloy powder is sintered by heating the alloy powder to a sintering temperature without applying pressure.

In the filling process, after the alloy powder is supplied to the main cavity, a press body having the same shape as the convex rib may preferably be pressed on the alloy powder from above. By this operation, the alloy powder can be shaped near the arched plate, whereby the uniformity of the filling density will be further improved.

In the orienting process, it is preferable to press the cover against the main body. By this operation, the alloy powder in the mold is prevented from leaking out of the mold due to the magnetic force. On the other hand, in the sintering process, it is preferable to simply place the cover on the main body without pressing it. This is because the effect of the leakage of the alloy powder in the sintering process is less serious than that of the leakage due to the magnetic force in the orienting process, and furthermore, because pressing the cover against the main body impedes the release from the mold of the gas resulting from the vaporization of the lubricant attached to the particles of the alloy powder. The lubricant is added when a lump of alloy is pulverized into powder and/or when the alloy powder is oriented. As noted earlier, entry of the alloy powder into the gap between the side cavity and the convex rib does not cause any problem since the cover can be easily removed from the mold.

### Advantageous Effects of the Invention

With the sintered magnet production mold and the sintered magnet production method according to the present invention, since the alloy powder can be easily placed in the mold, the uniformity in the filling density of the alloy powder can be improved, and the inside of the mold can be easily cleaned. Furthermore, the alloy powder is hardly caught in the gap between the cover and the cavity.

### BRIEF DESCRIPTION OF DRAWINGS

FIG. 1 is a perspective view showing the first embodiment of the sintered magnet production mold according to the present invention.

FIG. 2 is a top view and side view of the main body in the sintered magnet production mold of the first embodiment.

FIG. 3 is a top view and side view of the cover in the sintered magnet production mold of the first embodiment.

FIG. 4 is a perspective view of the sintered magnet production mold of the first embodiment, with the cover attached to the main body.

FIGS. 5A-5F are schematic side views showing one method of using the sintered magnet production mold of the first embodiment as well as one embodiment of the sintered magnet production method according to the present invention.

FIGS. 6A-6C are schematic perspective views showing one example of using a plurality of sintered magnet production molds of the first embodiment.

FIGS. 7A-7C are photographs showing one example of the main body of the sintered magnet production mold of the first embodiment and the arched plate magnet created with the same mold.

FIG. 8 is a perspective view showing the second embodiment of the sintered magnet production mold according to the present invention.

FIG. 9 is a top view and side view of the main body in the sintered magnet production mold of the second embodiment.

FIG. 10 is a top view and side view of the cover in the sintered magnet production mold of the second embodiment.

FIG. 11 a perspective view of the sintered magnet production mold of the second embodiment, with the cover attached to the main body.

FIG. 12 is a perspective view for illustrating the shape of an arched plate sintered magnet.

### DESCRIPTION OF EMBODIMENTS

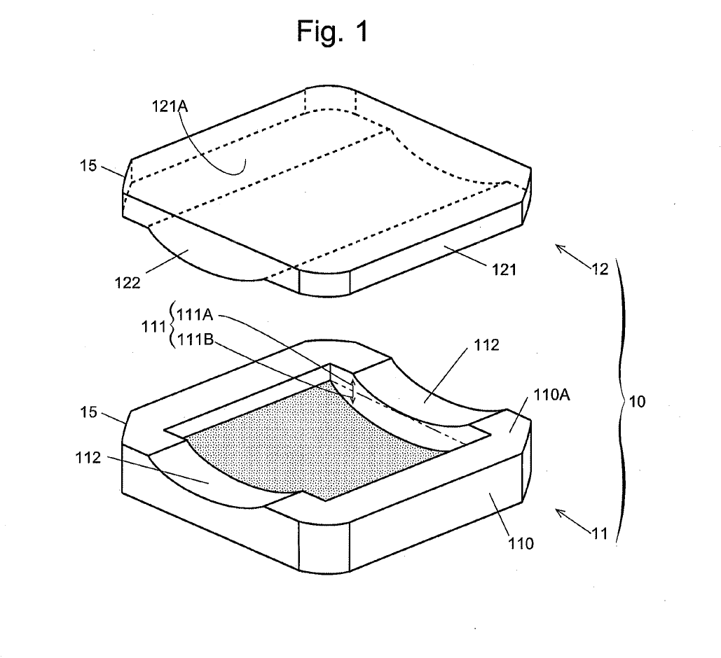

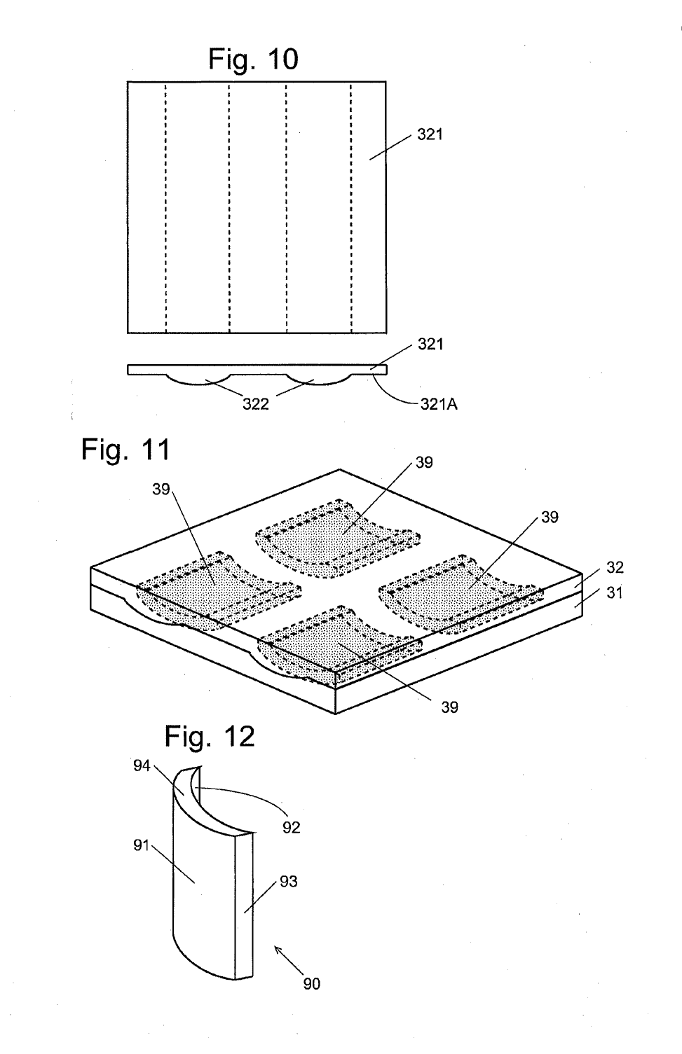

Embodiments of the sintered magnet production mold according to the present invention will be described using FIGS. 1-11.

### First Embodiment

The sintered magnet production mold 10 of the first embodiment is a mold to be used in the PLP method. As shown in FIGS. 1-3, it has a main body 11 and a cover 12. Both the main body 11 and the cover 12 are made of a material named “R8510”, a product which is manufactured by SGL Carbon Japan Co., Ltd. as a material for electrical spark-machining electrodes and is mainly made of graphite.

The main body 11 has a main member 110 shaped like a rectangular parallelepiped with its edges chamfered (as will be described later). A main cavity 111, which consists of an upper cavity 111A shaped like a rectangular parallelepiped and a lower cavity 111B shaped like a downward-convex partial cylinder directly joined to the upper cavity 111A, is formed from the top surface (main-body surface) 110A of the main member 110 into the inside of the main body 11. A side cavity 112, which has the shape of a partial cylinder formed from the main-body surface 110A into the inside of the main body 11, is provided on the outside of the opening of the upper cavity 111A at each of the two ends of the opening in the axial direction of the partial cylinder in the lower cavity 111B (accordingly, there are a total of two side cavities). The lower cavity 111B and the side cavities 112 have their respective axes of the partial cylinders directed parallel to each other.

The cover 12 has a top plate 121 and a convex rib 122 bulging from the lower surface (base surface) 121A of the top plate 121. The convex rib 122 is shaped like a partial cylinder. The shape of this partial cylinder corresponds to those of the partial cylinders in the two side cavities 112 provided in the main body 11. The top plate 121 and the convex rib 122 are integrally molded.

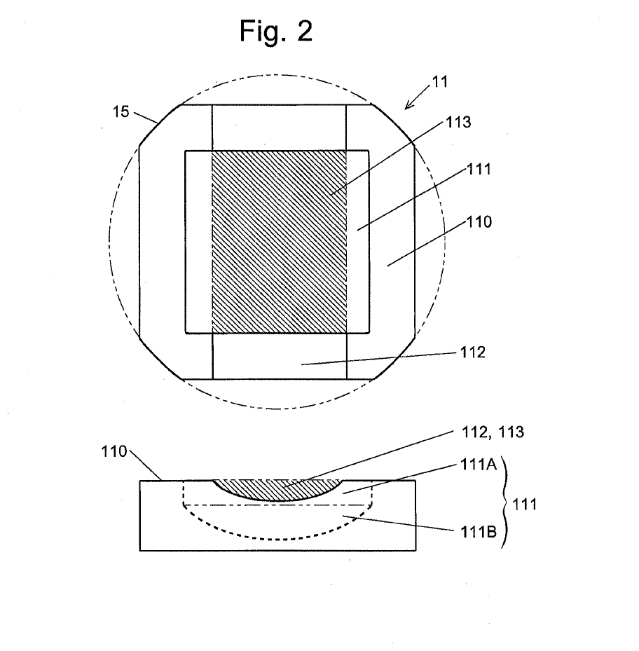

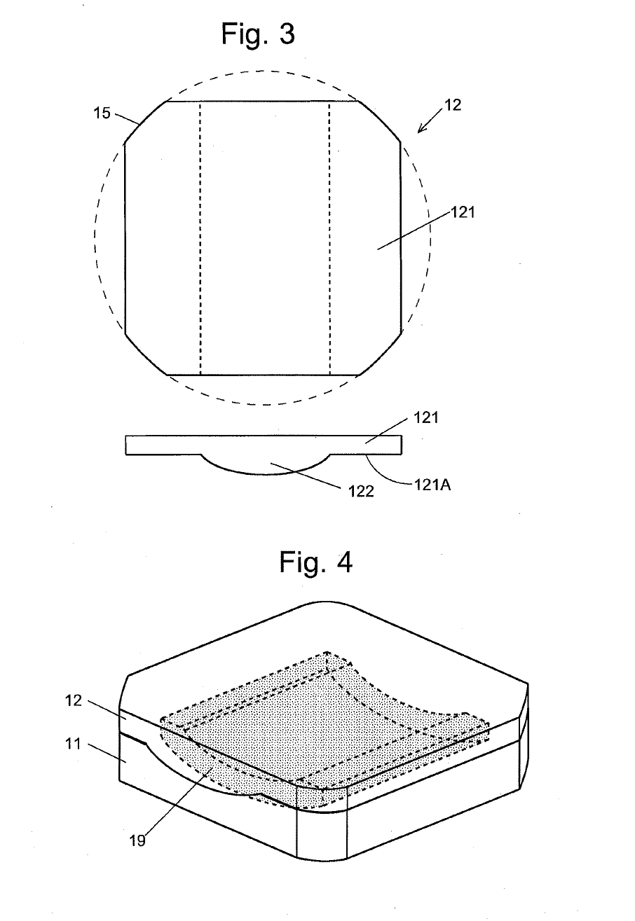

The main body 11 and the cover 12 have chamfered portions 15 formed by chamfering the four corners of the rectangle as viewed from above. The chamfered portions 15 are formed so that they describe a common circle on which those four corners lie (as indicated by the double-dot chained line or broken line in FIGS. 2 and 3).

The cover 12 can be attached to the main body 11 by being placed onto the main body 11 so that the base surface 121A matches the main-body surface 110A and the lower surface of the convex rib 122 matches the top surfaces of the side cavities 112. In this state, the convex rib 122 closes the two side cavities 112 and the virtual cavity 113 (the shaded area in FIG. 2) shaped like a partial cylinder connecting the two side cavities, leaving a powder-containing space 19 shaped like an arched plate within the main cavity 111 (FIG. 4). The powder-containing space 19 is nearly identical in shape to the sintered magnet to be produced (“near-net shape”) yet has a larger capacity which is previously determined according to the shrinkage factor in the sintering process.

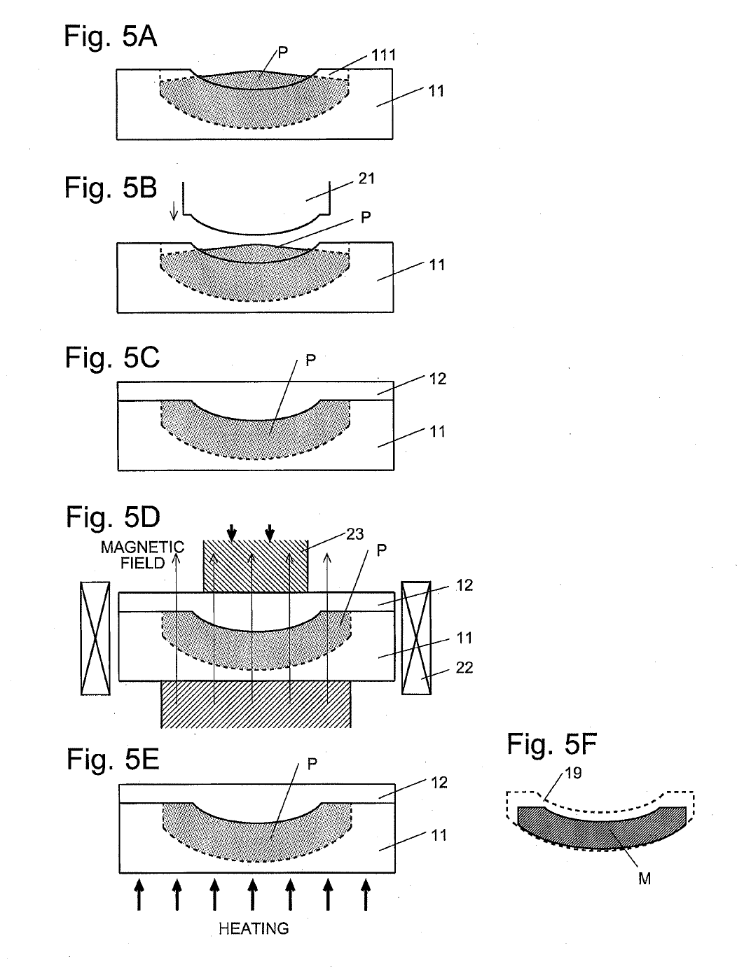

One example of the method of using the sintered magnet production mold 10 of the first embodiment is described by means of FIGS. 5A-5F. The following processes are performed in an inert gas so as to avoid oxidization of the alloy powder to be used as the raw material for the sintered magnet (this powder is hereinafter simply called the “alloy powder”).

Initially, the alloy powder P prepared as the raw material for the sintered magnet is supplied to the main cavity 111 by an amount corresponding to one sintered compact to be obtained as the final product (FIG. 5A). Next, a press body 21 consisting of a bar whose lower end is shaped identical to the convex rib 122 is pressed on the alloy powder P in the main cavity 111 from above (FIG. 5B). By this operation, the alloy powder P is shaped near the powder-containing space 19. Here, it is preferable to shake the main body 11 simultaneously with the contact of the press body 21. This makes the density of the alloy powder P closer to uniformity.

Subsequently, the cover 12 is attached to the main body 11 in the previously described manner (FIG. 5C). As a result, the alloy powder P is contained in the powder-containing space 19 shaped like an arched plate.

Next, the sintered magnet production mold 10 is placed in an air-core coil 22, and a magnetic field is applied to orient the alloy powder P (FIG. 5D). During this process, the cover 12 is pressed against the main body 11 by a piston 23, whereby the alloy powder P in the powder-containing space 19 is prevented from leaking out due to the magnetic force.

After that, the alloy powder P held in the powder-containing space 19 is heated to a predetermined sintering temperature to sinter the alloy powder P (FIG. 5E). For example, if the alloy powder P is a powder of an RFeB system alloy, the sintering temperature can be set within the range of 900-1050° C. During the sintering treatment, the volume of the entire powder decreases; i.e. the sintered compact gradually shrinks. Since the lower cavity 111B has a downward-convex shape, the sintered compact under the gravitational attraction naturally shrinks toward the lowest portion of the lower cavity 111B. Therefore, no crack will be formed in the sintered compact.

As a result of the previously described processes, a sintered magnet M shaped like an arched plate which is similar in shape to the powder-containing space 19 but is smaller in size than this space is obtained (FIG. 5F).

In the sintered magnet production mold 10 of the present embodiment, since the alloy powder P is supplied to the main-body cavity 11 through the opening corresponding to the concave surface which is larger than the side surface of the arched plate, it is easy to supply the alloy powder P and make the density of the alloy powder P uniform. The large opening also allows for easy cleaning. Furthermore, the situation in which the removal of the cover 12 is impeded by the alloy powder P being caught in the gap between the main body 11 and the cover 12 will not occur, since the cover 12 is not fitted into the main body 11 but is simply attached to it, with the base surface 121A in contact with the main-body surface 110A, and the lower surface of the convex rib 122 in contact with the upper surfaces of the side cavities 112.

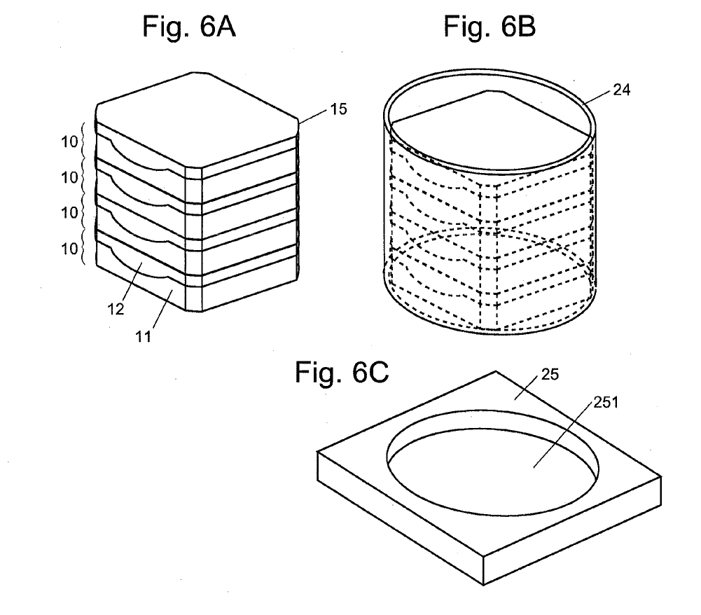

The description thus far has been concerned with the case of using a single sintered magnet production mold 10. In order to improve the productivity of the sintered magnet, it is more preferable to simultaneously perform the orienting and sintering processes on a plurality of sintered magnet production molds 10. In that case, as shown in FIG. 6A, a plurality of sintered magnet production molds 10 with the covers 12 attached to the respective main bodies 11 can be vertically stacked.

As shown in FIG. 6B, the vertically stacked sintered magnet production molds 10 may preferably be contained in a cylindrical outer casing 24 and be subjected to the orienting and sintering processes in this state. The radius of the inner wall of the outer casing 24 is previously designed to be equal to the radius of curvature of the circle described by the chamfered portions 15 of the sintered magnet production mold 10. Under the outer casing 24, a saucer 25 shown in FIG. 6C is provided which consists of a plate having a top surface in which a hollow 251 having the same radius as the outer wall of the outer casing 24 is formed. The outer casing 24 and the saucer 25 are made of the same material as the sintered magnet production mold 10. By using the outer casing 24 and the saucer 25, the plurality of sintered magnet production molds 10 can be handled as one object.

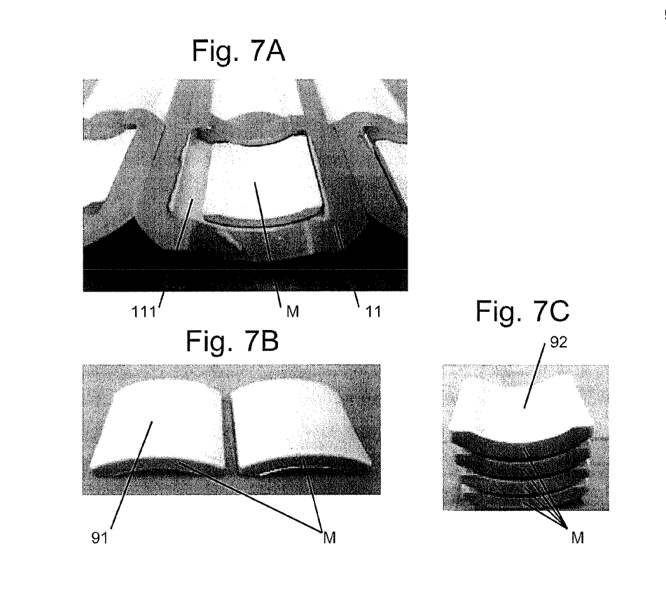

FIGS. 7A-7C show photographs of the main body 11 and an RFeB system sintered magnet M created with the sintered magnet production mold 10. Specifically, FIG. 7A is a photograph of the main body 11 and the sintered magnet M before being removed from the main body 11, obliquely taken from above. FIG. 7B is a photograph of the arched plate sintered magnets M, obliquely taken from above, with their convex surfaces 91 directed upward. FIG. 7C is a photograph of the same sintered magnets M, obliquely taken from above, with their concave surfaces 92 directed upward. As shown in these photographs, a sintered magnet M having an arched-plate shape corresponding to a shrunken version of the shape of the cavity of the main body 11 was obtained.

### Second Embodiment

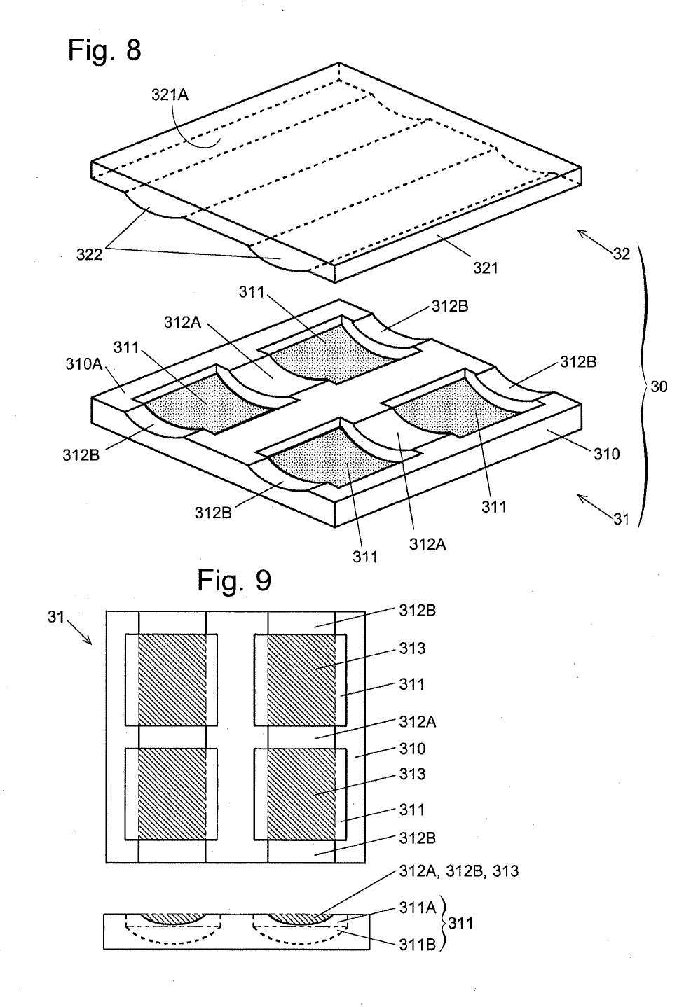

The sintered magnet production mold 30 of the second embodiment is a mold to be used in the PLP method and is configured so that a plurality of arched plate magnets can be simultaneously produced from a single mold. As shown in FIGS. 8-11, this sintered magnet production mold 30 has a main body 31 and a cover 32. Both the main 31 and the cover 32 are made of the same material as the sintered magnet production mold 10 of the first embodiment.

The main body 31 has a total of four main cavities 311 arranged in two rows and two columns on the top surface (main-body surface) 310A of the main member 310, with each main cavity 310 formed from the main-body surface 310A into the inside of the main body 31. Similar to the main cavity 111 in the first embodiment, each of the main cavities 311 consists of an upper cavity 311A shaped like a rectangular parallelepiped and a lower cavity 311B shaped like a downward-convex partial cylinder directly joined to the upper cavity 311A.

Between the two main cavities 311 neighboring each other in the axial direction of the aforementioned partial cylinder, a first side cavity 312A shaped like a partial cylinder is formed from the main-body surface 310A into the inside of the main body 31. Furthermore, at each of the two outer ends of those two neighboring main cavities 311, a second side cavity 312B shaped like a partial cylinder is formed from the main-body surface 310A into the inside of the main body 31.

The cover 32 has a top plate 321 and two convex ribs 322 bulging from the lower surface (base surface) 321A of the top plate 321. Each convex rib 322 is shaped like a partial cylinder corresponding to the shape of the first and second side cavities 312A and 312B provided in the main body 31. The two convex ribs 322 are arranged with the same spacing as the two main cavities 311 neighboring each other in the direction perpendicular to the aforementioned axis. The top plate 321 and the convex ribs 322 are integrally molded.

The cover 32 can be attached to the main body 31 by being placed onto the main body 31 so that the base surface 321 A matches the main-body surface 310A and the lower surface of each convex rib 322 matches the top surfaces of the first and second side cavities 312A and 312B. In this state, the convex rib 322 closes the first and second side cavities 312A and 312B as well as the virtual cavity 313 (the shaded area in FIG. 9) shaped like a partial cylinder connecting the two side cavities in the main cavity 311, leaving a powder-containing space 39 shaped like an arched plate within the main cavity 311 (FIG. 11).

The method of using the sintered magnet production mold 30 of the present embodiment is the same as the method of using the sintered magnet production mold 10 of the first embodiment except that the four main cavities 311 are individually supplied with the alloy powder P.

With the sintered magnet production mold 30 of the present embodiment, four arched plate sintered magnets can be simultaneously created with one set of the main body 31 and the cover 32. The attachment or removal of the cover 32, the shaking of the main body 31 in the process of filling the cavities with the alloy powder P, and other operations can be simultaneously performed on the four cavities. Therefore, the production efficiency of the arched plate sintered magnets will be improved.

The number of main cavities 311 is not limited to the previous example (i.e. a total of four cavities, with two cavities arranged in the aforementioned axial direction and two in the direction perpendicular to the axis); it is possible to provide the main body 31 with m main cavities 311 in the axial direction and n main cavities 311 in the direction perpendicular to the axis (m and n are positive integers; the case of m=n=1 corresponds to the first embodiment). In that case, the cover 32 is correspondingly provided with n convex ribs 322 arranged in the direction perpendicular to the axis, with each convex rib 322 common to the m main cavities 311 arranged in the axial direction.

### REFERENCE SIGNS LIST

10, 30 . . . Sintered Magnet Production Mold
11, 31 . . . Main Body
110, 310 . . . Main Member
110A, 310A . . . Main-Body Surface
111, 311 . . . Main Cavity
111A, 311A . . . Upper Cavity
111B, 311B . . . Lower Cavity
112 . . . Side Cavity
113, 313 . . . Virtual Cavity
12, 32 . . . Cover
121, 321 . . . Top Plate
121A, 321A . . . Base Surface
122, 322 . . . Convex Rib
15 . . . Chamfered Portion
19, 39 . . . Powder-Containing Space
21 . . . Press Body
22 . . . Air-Core Coil
23 . . . Piston
24 . . . Outer Casing
25 . . . Saucer
251 . . . Hollow in Saucer
312A . . . First Side Cavity
312B . . . Second Side Cavity
90 . . . Arched Plate Magnet
91 . . . Convex Surface
92 . . . Concave Surface
93 . . . Rectangular Side Surface
94 . . . Arched Side surface
M . . . Sintered Magnet

1. A sintered magnet production mold having a main body and a cover, wherein:
a) the main body has:
a-1) a main cavity formed inwards from a main-body surface, including an upper cavity shaped like a rectangular parallelepiped and a lower cavity shaped like a downward-convex partial cylinder directly joined to a deeper end of the upper cavity; and
a-2) a side cavity provided on an outside of an opening of the upper cavity on the main-body surface at each of two ends of the opening in an axial direction of the aforementioned partial cylinder, the side cavity formed inwards from the main-body surface and shaped like a partial cylinder having an axis parallel to an axis of the partial cylinder of the lower cavity;
and
b) the cover has a base surface corresponding to the main-body surface and a convex rib bulging from the base surface, the convex rib having a shape corresponding to the two side cavities and a virtual cavity shaped like a partial cylinder connecting the two side cavities.

2. The sintered magnet production mold according to claim 1, wherein:
the main body is provided with a plurality of the main cavities, where at least some of the main cavities are arranged in one direction, with one of the side cavities commonly provided between the main cavities neighboring each other in the aforementioned direction; and
the cover has the convex rib shaped like a partial cylinder longer than a distance between the two ends of the cavities arranged in the one aforementioned direction.

3. A sintered magnet production method, comprising following successive processes:
a filling process, in which a mold having a main body and a cove is filled with an alloy powder as a raw material, and subsequently, the cover is attached to the main body where a) the main body has a-1) a main cavity formed inwards from a main-body surface, including an upper cavity shaped like a rectangular parallelepiped and a lower cavity shaped like a downward-convex partial cylinder directly joined to a deeper end of the upper cavity, and a-2) a side cavity provided on an outside of an opening of the upper cavity on the main-body surface at each of two ends of the opening in an axial direction of the aforementioned partial cylinder, the side cavity formed inwards from the main-body surface and shaped like a partial cylinder having an axis parallel to an axis of the partial cylinder of the lower cavity, and where b) the cover has a base surface corresponding to the main-body surface and a convex rib bulging from the base surface, the convex rib having a shape corresponding to the two side cavities and a virtual cavity shaped like a partial cylinder connecting the two side cavities;
an orienting process, in which the alloy powder is magnetically oriented by applying a magnetic field to the alloy powder without applying pressure; and
a sintering process, in which the alloy powder is sintered by heating the alloy powder to a sintering temperature without applying pressure.

4. The sintered magnet production method according to claim 3, wherein, in the filling process, a press body having a same shape as the convex rib is pressed on the alloy powder from above after the alloy powder is supplied to the main cavity.

5. The sintered magnet production method according to claim 3, wherein, in the orienting process, the cover is pressed against the main body.

6. The sintered magnet production method according to claim 3, wherein:
the main body is provided with a plurality of the main cavities, where at least some of the main cavities are arranged in one direction, with one of the side cavities commonly provided between the main cavities neighboring each other in the aforementioned direction; and
the cover has the convex rib shaped like a partial cylinder longer than a distance between the two ends of the cavities arranged in the one aforementioned direction.

7. The sintered magnet production method according to claim 6, wherein, in the filling process, a press body having a same shape as the convex rib is pressed on the alloy powder from above after the alloy powder is supplied to the main cavity.

8. The sintered magnet production method according to claim 4, wherein, in the orienting process, the cover is pressed against the main body.

9. The sintered magnet production method according to claim 6, wherein, in the orienting process, the cover is pressed against the main body.

10. The sintered magnet production method according to claim 7, wherein, in the orienting process, the cover is pressed against the main body.
